(19) United States
(12) Patent Application Publication
(10) Pub. No.: US 2025/0016755 A1
(43) Pub. Date: Jan. 9, 2025

(54) ROTATING RESOURCE UNITS IN FRAMES FOR WIRELESS COMMUNICATIONS

(71) Applicant: NXP USA, Inc., Austin, TX (US)

(72) Inventors: Rong Zhang, San Jose, CA (US); Rui Cao, Sunnyvale, CA (US); Hongyuan Zhang, Fremont, CA (US)

(21) Appl. No.: 18/766,363

(22) Filed: Jul. 8, 2024

Related U.S. Application Data
(60) Provisional application No. 63/512,245, filed on Jul. 6, 2023.
(60) Provisional application No. 63/552,854, filed on Feb. 13, 2024.
(60) Provisional application No. 63/560,364, filed on Mar. 1, 2024.

(51) Int. Cl. H04W 72/0453; H04L 5/00; H04W 72/0446

(52) U.S. Cl. CPC H04W 72/0453; H04L 5/0012; H04W 72/0446

(57) ABSTRACT

Embodiments of a wireless device and method are disclosed. In an embodiment, a wireless device comprises a wireless transceiver to receive and transmit frames, and a controller operably coupled to the wireless transceiver to process the frames, wherein the controller is configured to generate at least one frame that includes a resource unit for a first user that is rotated in frequency such that a first frequency location of the resource unit for a first time period is different than a second frequency location of the resource unit for a second time period.

### CROSS-REFERENCE TO RELATED APPLICATIONS

This application is entitled to the benefit of U.S. Provisional Patent Application Ser. No. 63/512,245, filed on Jul. 6, 2023, U.S. Provisional Patent Application Ser. No. 63/552,854, filed on Feb. 13, 2024, and U.S. Provisional Patent Application Ser. No. 63/560,364, filed on Mar. 1, 2024, which are incorporated herein by reference.

### BACKGROUND

In the 802.11ax and 802.11be protocols, downlink (DL) Orthogonal Frequency Division Multiple Access (OFDMA) constitutes an important and mandatory mode of operation. It improves efficiency via overhead reduction by concurrently scheduling multiple users over their respectively assigned Resource Units (RUs). In these protocols, the RU assigned to each user has a fixed subcarrier location over the entire physical layer protocol data unit (PPDU). For example, user 1 (U1) may be assigned with fifty-two (52) subcarriers RU at location 1 (RU52[1]) at subcarrier range [−121:−70] of a 20 megahertz (MHz) PPDU.

There are two disadvantages of this fixed RU allocation. First, fixed RU has narrower exposure to frequency diversity, so that the receive sensitivity is degraded. Second, fixed RU has weaker tolerance to narrow band interference, so that the packet error rate (PER) under interference is elevated.

### SUMMARY

Embodiments of a wireless device and method are disclosed. In an embodiment, a wireless device comprises a wireless transceiver to receive and transmit frames, and a controller operably coupled to the wireless transceiver to process the frames, wherein the controller is configured to generate at least one frame that includes a resource unit for a first user that is rotated in frequency such that a first frequency location of the resource unit for a first time period is different than a second frequency location of the resource unit for a second time period.

In an embodiment, the controller is configured to assign frequency locations of the resource unit in one of a full span, a partial span and a mixed span, wherein the full span is a span where a total available bandwidth is visited by the resource unit, wherein the partial span is a span where less than the total available bandwidth is visited by the resource unit, and the mixed span is a span that includes at least one full span and at least one partial span.

In an embodiment, the controller is configured to assign frequency locations of the resource unit such that at least one frequency range is hopped by the frequency locations of the resource unit.

In an embodiment, the controller is configured to assign frequency locations of the resource unit such that the frequency locations have mixed sizes.

In an embodiment, the resource unit includes a multiple resource unit.

In an embodiment, the controller is configured to assign frequency locations of the resource unit such that one of a punctured area, a reserved area and a partitioned area of a total available bandwidth is not visited by the frequency locations.

In an embodiment, the controller is configured to use unoccupied bits of a signal element of the frame or symbols in the frame to provide information for reception of the frame with the resource unit.

In an embodiment, the controller is configured to use an existing spatial mapping matrix when there is no transmit beamforming, and use an averaged spatial mapping matrix when there is transmit beamforming.

In an embodiment, the controller is configured to use one long training field when there is no transmit beamforming, and use a long training field per user when there is no transmit beamforming.

In an embodiment, the controller is configured to generate a long training field in the frame with a sparse tone plan, wherein the sparse tone plan uses less than half of available tones.

In an embodiment, the controller is configured to generate a preamble in the frame that is power boosted by up to one of six (6) decibels or power boosted to three (3) decibels and six (6) decibels.

In an embodiment, the controller is configured to generate a short or long training field in the frame that is power boosted, wherein a time domain repetition is applied to the short or long training field.

In an embodiment, the sparse tone plan includes at least one of twenty-four (24) data tones, twenty-eight (28) data tones, forty-eight (48) data tones, fifty-two (52), data tones fifty-six (56) data tones, ninety-six (96) data tones, one hundred two (102) data tones, and one hundred fourteen (114) data tones.

In an embodiment, the sparse tone plan includes a particular number of data tones to support at least one of one (1) megabits per second, 1.5 megabits per second, two (2) megabits per second, three (3) megabits per second, and four (4) megabits per second.

In an embodiment, the sparse tone plan is one of an offset sparse tone plan and a non-uniform sparse tone plan.

In an embodiment, a method of transmitting a frame in a communications system, the method comprises assigning a first user with first resource unit locations in the frame that are rotated in frequency, and assigning a second user with second resource unit locations in the frame that are rotated in frequency such that at least one of the first resource unit locations and at least one of the second resource unit locations are in a same subcarrier range.

In an embodiment, assigning the first user with the first resource unit locations in the frame includes assigning the first resource unit locations in one of a full span, a partial span and a mixed span, wherein the full span is a span where a total available bandwidth is visited by a resource unit associated with the first resource unit locations, wherein the partial span is a span where less than the total available bandwidth is visited by the resource unit, and the mixed span is a span that includes at least one full span and at least one partial span.

In an embodiment, a wireless device comprises a wireless transceiver to receive and transmit frames, and a controller operably coupled to the wireless transceiver to process the frames, wherein the controller is configured to generate at one frame that includes first resource unit locations in the frame for a first user that are rotated in frequency and second resource unit locations in the frame for a second user that are rotated in frequency such that at least one of the first resource unit locations and at least one of the second resource unit locations are in a same subcarrier range.

In an embodiment, the controller is configured to assign the first resource unit locations in one of a full span, a partial span and a mixed span, wherein the full span is a span where a total available bandwidth is visited by a resource unit associated with the first resource unit locations, wherein the partial span is a span where less than the total available bandwidth is visited by the resource unit, and the mixed span is a span that includes at least one full span and at least one partial span.

In an embodiment, the controller is configured to assign the first resource unit locations such that at least one frequency range is hopped by the first resource unit locations.

Other aspects in accordance with the invention will become apparent from the following detailed description, taken in conjunction with the accompanying drawings, illustrated by way of example of the principles of the invention.

### BRIEF DESCRIPTION OF DRAWINGS

FIG. 1 depicts a multi-link communications system for wireless communications that can be used in embodiments of the invention.

FIG. 2A illustrates a physical layer protocol data unit (PPDU) with fixed resource units (RUs) in accordance with prior art.

FIG. 2B is a graph showing mean power for different RUs in accordance with prior art.

FIG. 3 illustrates a PPDU with full span rotated RUs in accordance with an embodiment of the invention.

FIG. 4A illustrates a PPDU with partial span rotated RUs in accordance with an embodiment of the invention.

FIG. 4B illustrates a PPDU with full and partial span rotated RUs in accordance with an embodiment of the invention.

FIG. 5 illustrates a PPDU where RUs are rotated in frequency with hopping patterns in accordance with an embodiment of the invention.

FIG. 6 illustrates a PPDU where mixed size RUs are rotated in frequency in accordance with an embodiment of the invention.

FIG. 7 illustrates a PPDU with mixed size RUs where rotating RUs are not allowed in accordance with an embodiment of the invention.

FIG. 8 illustrates a PPDU with a multiple resource unit that is rotated in frequency in accordance with an embodiment of the invention.

FIG. 9 illustrates a PPDU where RUs are rotated in frequency in the presence of a reserved area in accordance with an embodiment of the invention.

FIG. 10 illustrates a PPDU where RUs are rotated in frequency in the presence of a punctured area in accordance with an embodiment of the invention.

FIG. 11 illustrates a PPDU where RUs are rotated in frequency within partitioned areas in accordance with an embodiment of the invention.

FIG. 12 illustrates a PPDU with ultra-high reliability Long Training Field (UHRLTF) per user and per stream in accordance with an embodiment of the invention.

FIG. 13 illustrates a PPDU where time domain repetition is applied of extended range Short Training Field (ER-STF) and extended range Long Training Field (ER-LTF) in accordance with an embodiment of the invention.

FIG. 14 illustrates an ultra-high reliability (UHR) extended range (ER) PPDU with sparse tone plan in accordance with an embodiment of the invention.

FIG. 15 illustrates a PPDU with legacy signal (L-SIG), repeated legacy signal (RL-SIG) and Universal Signal (U-SIG) in accordance with an embodiment of the invention.

FIG. 16 illustrates a PPDU with U-SIG removed in accordance with an embodiment of the invention.

FIG. 17 depicts a wireless device in accordance with an embodiment of the invention.

FIG. 18 illustrates a flow diagram of a method of transmitting a frame in a communications system in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

Several aspects of WiFi systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

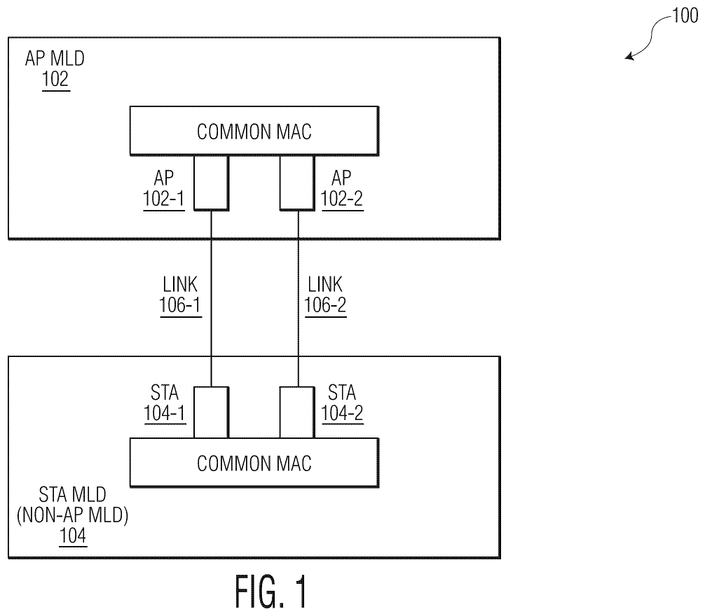

FIG. 1 depicts a multi-link communications system 100 for wireless (e.g., WiFi) communications that can be used in embodiments of the invention. In the embodiment depicted in FIG. 1, the multi-link communications system includes one access point (AP) multi-link device (MLD) 102, and one station (STA) MLD (non-AP MLD) 104. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Various iterations of the 802.11 specification are referred to herein. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). The terms VHT, HE, EHT, and UHR may be used in the descriptions found herein.

Although the depicted multi-link communications system 100 is shown in FIG. 1 with certain components and described with certain functionality herein, other embodiments of the multi-link communications system may include fewer or more components to implement the same, less, or more functionality. For example, in some embodiments, the multi-link communications system includes a single AP MLD and multiple associated STA MLDs, or multiple AP MLDs and multiple STA MLDs with each STA MLD being associated with an AP MLD. In some embodiments, the legacy STAs (non-HE STAs) associate with one of the APs affiliated with the AP MLD. In some embodiments, an AP MLD may have a single affiliated AP. In some embodiments, a STA MLD may have a single affiliated STA. In another example, although the multi-link communications system is shown in FIG. 1 as being connected in a certain topology, the network topology of the multi-link communications system is not limited to the topology shown in FIG. 1.

In the embodiment depicted in FIG. 1, the AP MLD 102 includes two access points (APs) 102-1 and 102-2. In some embodiments, the AP MLD 102 implements upper layer Media Access Control (MAC) functionalities (e.g., association establishment, reordering of frames, etc.) and the APs 102-1 and 102-2 implement lower layer MAC functionalities (e.g., backoff, frame transmission, frame reception, etc.). The 102-1 and 102-2 may be implemented in hardware (e.g., circuits), software, firmware, or a combination thereof. The APs 102-1 and 102-2 may be fully or partially implemented as an integrated circuit (IC) device. In some embodiments, the APs 102-1 and 102-2 may be wireless APs compatible with at least one WLAN communications protocol (e.g., at least one IEEE 802.11 protocol). For example, the APs 102-1 and 102-2 may be wireless APs compatible with the IEEE 802.11bn protocol.

In some embodiments, an AP MLD 102 connects to a local area network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 102-1 and/or AP2 102-2) includes multiple RF chains. In some embodiments, an AP (e.g., AP1 102-1 and/or AP2 102-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 102-1 and 102-2 of the AP MLD 102 with multiple RF chains may operate in a different basic service set (BSS) operating channel (in a different link). For example, AP1 102-1 may operate in a 320 MHz BSS operating channel at 6 GHz band, and AP2 102-2 may operate in a 160 MHz BSS operating channel at 5 GHz band. Although the AP MLD 102 is shown in FIG. 1 as including two APs, other embodiments of the AP MLD 102 may include only one AP or more than two APs.

In the embodiment depicted in FIG. 1, the non-AP STA MLD 104 includes two non-AP STAs 104-1 and 104-2. The STAs 104-1 and 104-2 may be implemented in hardware (e.g., circuits), software, firmware, or a combination thereof. The STAs 104-1 and 104-2 may be fully or partially implemented as an IC device. In some embodiments, the STAs 104-1 and 104-2 are part of the STA MLD 104, such that the STA MLD may be a communications device that wirelessly connects to a wireless AP MLD. For example, the STA MLD 104 may be implemented in a laptop, a desktop personal computer (PC), a mobile phone, or other communications device that supports at least one WLAN communications protocol. In some embodiments, the non-AP STA MLD 104 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 104 implements a common MAC functionality and the non-AP STAs 104-1 and 104-2 implement a lower layer MAC data functionality.

In some embodiments, the AP MLD 102 and/or the STA MLD 104 may identify which communication links support multi-link operation during a multi-link operation setup phase and/or exchanges information regarding multi-link capabilities during the multi-link operation setup phase. In some embodiments, each of the non-AP STAs 104-1 and 104-2 of the STA MLD 104 may operate in a different frequency band. For example, the non-AP STA 104-1 in one link may operate in the 2.4 GHz frequency band and the non-AP STA 104-2 in another link may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 1, the STA MLD 104 communicates with the AP MLD 102 via two communication links 106-1 and 106-2. For example, each of the non-AP STAs 104-1 and 104-2 communicates with an AP 102-1 or 102-2 via a corresponding communication link 106-1 or 106-2. In an embodiment, a communication link (e.g., link 106-1 or link 106-2) may include a BSS operating channel established by an AP (e.g., AP 102-1 or AP 102-2) that features multiple 20 MHz channels used to transmit frames (e.g., Beacon frames, management frames, etc.) being carried in Physical Layer Convergence Protocol (PLCP) Protocol Data Units (PPDUs) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 104 is shown in FIG. 1 as including two non-AP STAs, other embodiments of the STA MLD 13 may include one non-AP STA or more than two non-AP STAs. In addition, although the AP MLD 102 communicates (e.g., wirelessly communicates) with the STA MLD 104 via multiple links 106 and 106-2, in other embodiments, the AP MLD 102 may communicate (e.g., wirelessly communicate) with the STA MLD 104 via one communication link or more than two communication links.

As described above a multi-link AP MLD has one or multiple links where each link has one AP affiliated with the AP MLD. This may be accomplished by having the different radios for the different affiliated APs. A multi-link STA MLD has one or multiple links where each link has one STA affiliated with the STA MLD. One way to implement the multi-link STA MLD is using two or more radios, where each radio is associated with a specific link. For example, a multi-link multi-radio (MLMR) non-AP MLD may be used. The MLMR non-AP MLD uses multiple full functional radios to monitor the medium in multiple links. Another way to implement the multi-link STA MLD is using a single radio in two different bands. Each band may be associated with a specific link. In this case, only one link is available at a time. In yet another implementation, an enhanced single-radio (ESR) STA MLD may be used that operates in an enhanced multi-link single radio (eMLSR) mode. The ESR STA MLD uses two radios in different bands to implement the MLD. For example, one radio may be a lower cost radio with lesser capabilities and the other radio may be a fully functional radio supporting the latest protocols. The ESR STA MLD may dynamically switch its working link while it can only transmit or receive through one link at any time. The ESR STA MLD may monitor two links simultaneously, for example, detecting medium idle/busy status of each link, or receiving a PPDU on each link. Each radio may have its own backoff time, and when the backoff counter for one of the radios becomes zero, that radio and link may be used for transmission. For example, if an AP wants to use the fully functional radio, it may send a control frame that is long enough for the ESR STA MLD to switch from the lesser capable radio to the fully functional radio that may then transmit data to the AP. When an extended service set (ESS) includes multiple AP MLDs in different locations and a STA MLD executed the data frame exchanges with one of the AP MLDs (e.g., AP MLD1), as the STA MLD moves to other location to do the data frame exchanges with another one of the AP MLDs (say AP MLD2), the STA MLD (same as a non-AP MLD herein) needs to finish the association with AP MLD2 before doing the data frame exchanges with AP MLD2. There is a requirement to decrease the number of associations within the ESS.

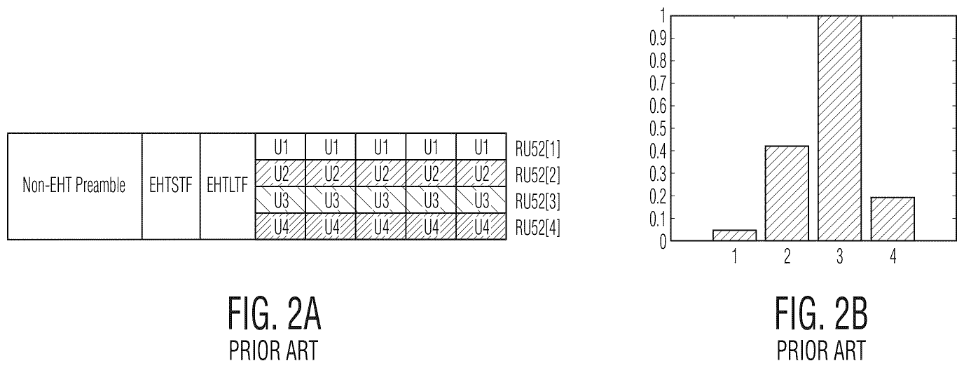

In the 802.11ax and 802.11be protocols, downlink (DL) Orthogonal Frequency Division Multiple Access (OFDMA) constitutes an important and mandatory mode of operation. The principle is to assign each user a distinct Resource Unit (RU) in frequency domain. In these protocols, fixed RU allocation is employed, where the RU assigned to each user has a fixed subcarrier location over the entire PPDU. For example, as shown in FIG. 2A, user U1 is assigned with fifty-two (52) subcarriers RU at location 1 (RU52[1]) with subcarrier range [−121:−70] of a 20 MHz PPDU. Users U2, U3 and U4 are similarly assigned with RU52 at location 2 (RU52(2)) with subcarrier range [−68:−17], RU52 at location 3 (RU52(3)) with subcarrier range [17:68] and RU52 at location 4 (RU52(4)) with subcarrier range [70:121], respectively.

However, using fixed RU allocation has disadvantages. The first disadvantage is that wireless channel is frequency selective in nature, where the channel gains and fades differently over RUs as shown in FIG. 2B, which shows mean power for different RUs 1-4. Hence, fixed RU has narrower exposure to frequency diversity, so that the receive sensitivity is degraded. The second disadvantage is that a wireless system may encounter narrowband interference, which can seriously degrade a cluster of frequency tones. Hence, fixed RU has weaker tolerance to narrow band interference, so that the packet error rate (PER) under interference is elevated.

In order to alleviate these disadvantages, embodiments of the invention utilize rotated RUs with respect to frequency for transmission, e.g., DL OFDMA, in an appropriate WiFi protocol, such as the next-gen WiFi Ultra High Reliability (UHR). The core concept is that each user's RU location is rotated in frequency at different time periods and multiple users' rotating RUs are nonoverlapping. It is noted here that there is no need to define a new OFDMA/RU tone map to rotate the RUs in accordance with the embodiments of the invention.

The concept of spanning bandwidth, which is the bandwidth the user's rotating RU visits, is now introduced. Spanning bandwidth may be full span, partial span or mixed span, which are each described below.

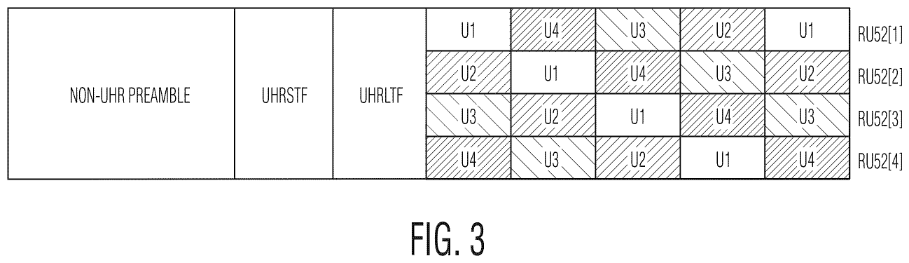

Full span means that the rotating RU visits all available bandwidth. An example of full span rotated RUs in accordance with an embodiment of the invention are illustrated in FIG. 3. In FIG. 3, a PPDU is shown with a non-UHR preamble, a UHR Short Training Field (UHRSTF), UHR Long Training Field (UHRLTF) and RUs (labeled with users U1-U4). As shown in FIG. 3, the user U1 is assigned with RU52, where its location is rotated in frequency. Specifically, the user U1 is located at RU52[1] with subcarrier range [−121:−70] in 1^{st} data symbol, at RU52[2] with subcarrier range [−68:−17] in 2^{nd} data symbol, at RU52[3] with subcarrier range [17:68] in 3^{rd} data symbol and at RU52[4] with subcarrier range [70:121] in 4^{th} data symbol, where the different data symbols correspond to different time periods. The rotating pattern repeats thereafter. Similarly, other users, i.e., users U2, U3 and U4, are assigned with RU52 placed in their respective rotated locations. As shown in FIG. 3, the rotated RU locations for all users are non-overlapping. That is, only one user is assigned to each of the RU locations with respect to frequency and time. It is noted here that associated changes may be needed in the signal field (SIG), UHRSTF and UHRLTF to support this feature, where those changes are detailed later separately.

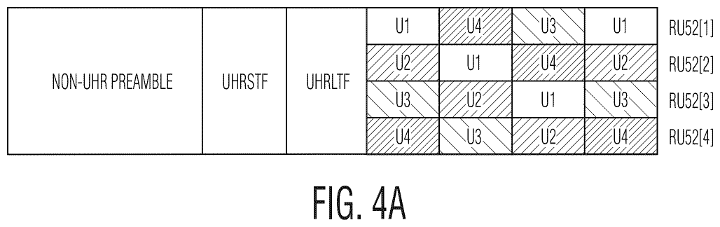

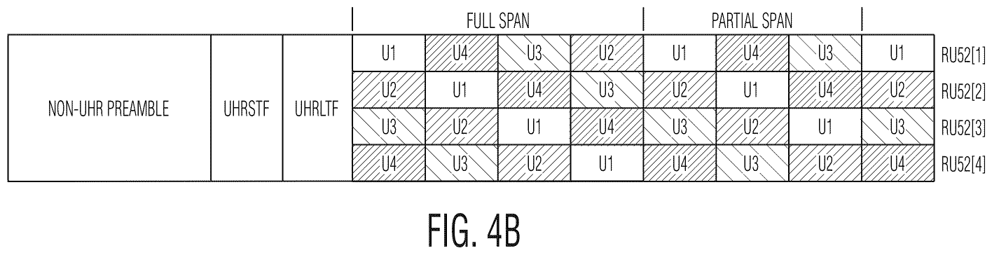

A rotating RU is allowed to have a partial span, where the spanning bandwidth is less than the total bandwidth, i.e., all available bandwidth that can be visited by a RU. This means that a rotating RU can visit a portion of the total available bandwidth. For example, as shown in FIG. 4A, the user U1 is assigned with RU52, where its location is rotated in frequency. Specifically, the user U1 is located at RU52[1] with subcarrier range [−121:−70] in 1^{st} data symbol, at RU52[2] with subcarrier range [−68:−17] in 2^{nd} data symbol, at RU52[3] with subcarrier range [17:68] in 3^{rd} data symbol. The rotating pattern repeats thereafter. In partial span, the user U1 can never visit RU52[4] with subcarrier range [70:121]. The RUs of the other users have similar rotating patterns.

A rotating RU is allowed to have a mixed span. This means that a rotating RU can sometimes visit full or total bandwidth and sometimes visit a portion of the total available bandwidth. For example, as shown in FIG. 4B, a PPDU is formed by rotating the RU for each user, e.g., the user U1, in full span for four (4) data symbols and partial span for three (3) data symbols. The cascaded rotating pattern repeats thereafter. The sequence of full and partial spans can be pre-determined, e.g., full-partial, partial-full, full-partial-partial, etc.

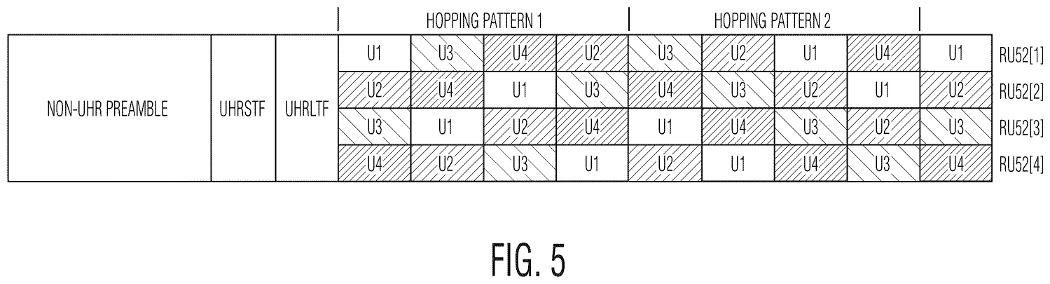

In some embodiments, a rotating RU is allowed to have a specific hopping pattern, where the rotating RU may hop or skip a frequency range, e.g., RU52(2). More than one hopping pattern can be cascaded. The purpose of hopping is to increase security at the physical layer against eavesdropping. In a full span, for example, as shown in FIG. 5, the user U1 is assigned with RU52, where its location is rotated in frequency with two hopping patterns cascaded. With the first hopping pattern, i.e., the hopping pattern 1, the user U1 is located at RU52[1] with subcarrier range [−121:−70] in 1st data symbol, at RU52[3] with subcarrier range [17:68] in 2^{nd} data symbol, at RU52[2] with subcarrier range [−68:−17] in 3^{rd} data symbol and at RU52[4] with subcarrier range [70:121] in 4^{th} data symbol. With the second hopping pattern, i.e., the hopping pattern 2, the user U1 is located at RU52[3] with subcarrier range [17:68] in 5^{th} data symbol, at RU52[4] with subcarrier range [70:121] in 6th data symbol, at RU52[1] with subcarrier range [−121:−70] in 7^{th} data symbol and at RU52[2] with subcarrier range [−68:−17] in 8^{th} data symbol. The cascaded hopping pattern repeats thereafter.

Hopping is also applicable in partial and mixed spans. In a mixed span, a hopping pattern in a full span can be mixed and cascaded with a hopping pattern in a partial span. Embodiments of the invention are not limited to any specific hopping patterns or their generation methods.

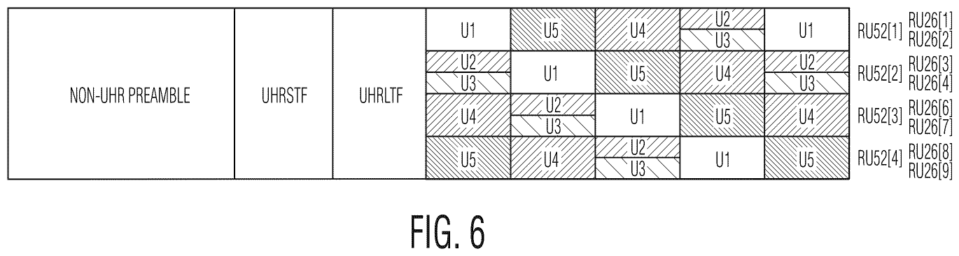

A rotating RU is allowed to have a mixed size, given that the tone plans of mixed size RUs for each user are non-conflicting. In a full span, for example, as shown in FIG. 6, the users U1, U4 and U5 are assigned with RU52, while U2 and U3 are assigned with twenty-six (26) subcarriers RU (RU26). Since there is no tone plan conflict between RU52 and RU26, rotating RUs of mixed sizes can coexist. In FIG. 6, the user U1, for example, is located at RU52[1] with subcarrier range [−121:−70] in 1st data symbol, at RU52[2] with subcarrier range [−68:−17] in 2^{nd} data symbol, at RU52[3] with subcarrier range [17:68] in 3^{rd} data symbol and at RU52[4] with subcarrier range [70:121] in 4^{th} data symbol. The rotating pattern repeats thereafter. The user U2, for example, is located at RU26 [3] with subcarrier range [−68:−43] in 1st data symbol, at RU26 [6] with subcarrier range [17:42] in 2^{nd} data symbol, at RU26 [8] with subcarrier range [70:95] in 3^{rd} data symbol and at RU26 [1] with subcarrier range [−121:−96] in 4^{th} data symbol. The rotating pattern repeats thereafter.

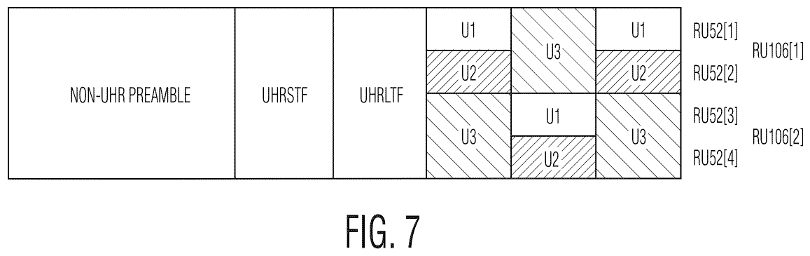

If there is a tone plan conflict, then rotating RUs are not allowed. In a full span, for example, as shown in FIG. 7, the users U1 and U2 are assigned with RU52, while the user U3 is assigned with one hundred and six (106) subcarriers RU (RU106). Since the tone plan conflicts between RU106 and RU52, rotating RUs are not allowed. A mixed size RU is also applicable in partial and mixed spans. Mixed size RU can also have hopping.

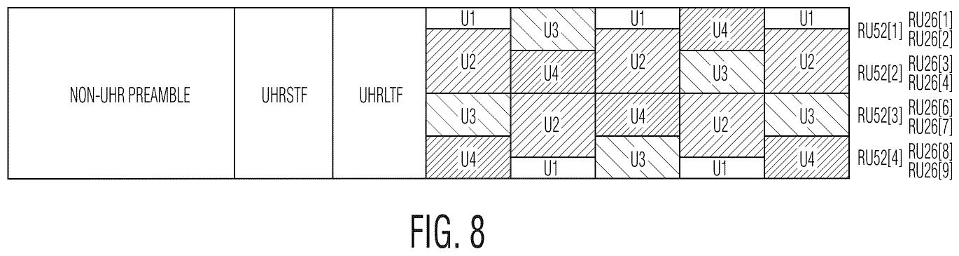

In some embodiments, a rotating RU is allowed to have a Multiple Resource Unit (MRU), which is a concatenation-based RU tone plan introduced in 802.11be that assigns multiple RUs to a user. In a full span, for example, as shown in FIG. 8, the user U1 is assigned with RU26, the user U2 is assigned with MRU52+26 (i.e., a combination of RU52 and RU26), while the users U3 and U4 are assigned with RU52, all supporting rotation. The user U1 is located at RU26[1] with subcarrier range [−121:−96] in 1st data symbol, at RU26[9] with subcarrier range [96:121] in 2^{nd} data symbol. The rotating pattern repeats thereafter. The user U2 is located at MRU52+26[1] with subcarrier range [−95:−17] in 1st data symbol, at MRU52+26[3] with subcarrier range [17:95] in 2^{nd} data symbol. The rotating pattern repeats thereafter. The user U3 is located at RU52[3] with subcarrier range [17:68] in 1st data symbol, at RU52[1] with subcarrier range [−121:−70] in 2^{nd} data symbol, at RU52[4] with subcarrier range [70:121] in 3^{rd} data symbol and at RU52[2] with subcarrier range [−68:−17] in 4^{th} data symbol. The rotating pattern repeats thereafter.

An MRU is also applicable in partial and mixed spans. An MRU can also have hopping. An MRU is a mixed size RU and can coexist with another mixed size RU.

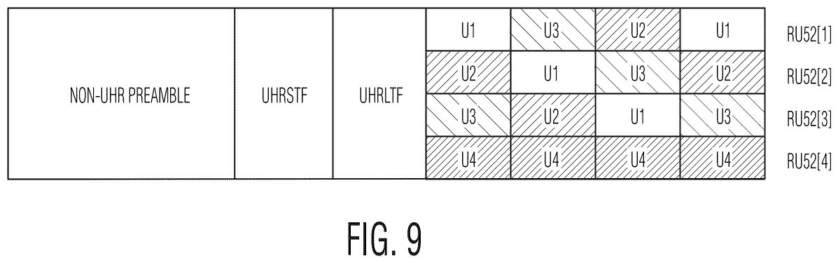

In some embodiments, a rotating RU is allowed to work in the presence of a reserved area, which is the area of the bandwidth no rotating RU can visit. This applies when some users do not want to participate in the rotating mode. Hence, the reserved area ensures compatibility when grouping UHR and non-UHR users. In this case, the maximum spanning bandwidth is the total bandwidth excluding the reserved bandwidth. In a full span, for example, as shown in FIG. 9, the users U1, U2 and U3 are assigned with RU52 supporting rotation, while the user U4 is assigned with RU52[4] fixed at subcarrier range [70:121]. As a result, RU52[4] is reserved where no rotating RU can visit, i.e., RU52[4] is the reserved area.

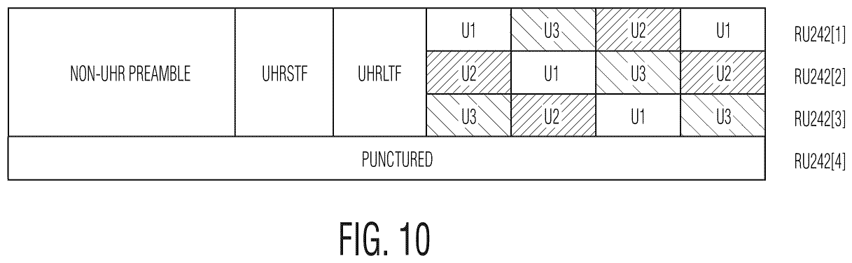

In some embodiments, a rotating RU is allowed to work in the presence of a punctured area. Punctured transmission is introduced in 802.11ax and 802.11be, where some of the 20 MHz channels are excluded. In this case, the maximum spanning bandwidth is the total bandwidth excluding the punctured bandwidth. In a full span, for example, as shown in FIG. 10, the highest 20 MHz channel is punctured in an 80 MHz PPDU (depicted as “Punctured”). A non-reserved or non-punctured area is also applicable in partial and mixed spans. A non-reserved or non-punctured area can also have hopping. A non-reserved or non-punctured area can also have a mixed size RU and/or an MRU.

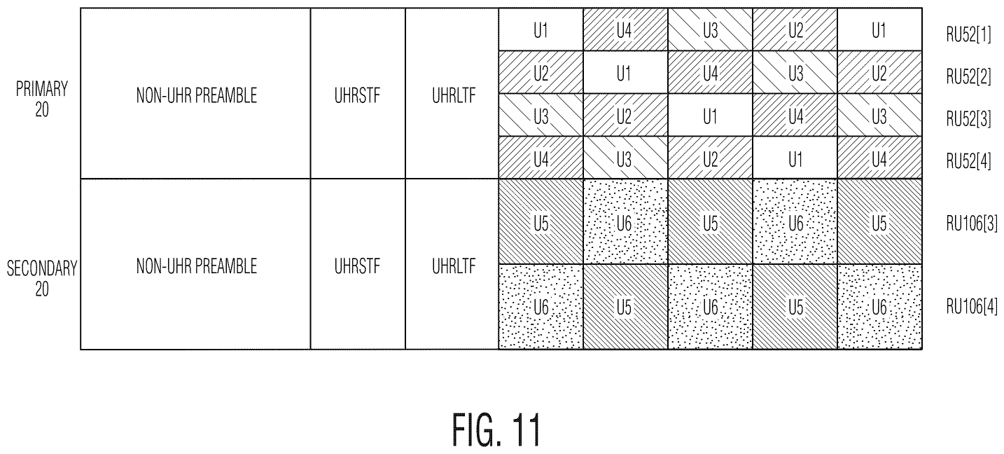

In some embodiments, a rotating RU is allowed to work within a partitioned area, which covers a portion of the total bandwidth. This brings a smaller number of rotation combinations for a large bandwidth PPDU. In this case, the maximum spanning bandwidth is the partitioned bandwidth. For example, a 40 MHz PPDU can be partitioned into two 20 MHZ areas. A rotating RU is limited within each of the partitioned areas and then the maximum spanning bandwidth is 20 MHz after partition. A partitioned area may or may not be in 20 MHz resolution, and may or may not be in the same size. In a full span, for example, as shown in FIG. 11, the users U1, U2, U3 and U4 are assigned with RU52 rotating in the primary 20 MHz, while the users U5 and U6 are assigned with RU106 rotating in the secondary 20 MHz.

Each partitioned area is also applicable in partial and mixed spans. Each partitioned area can also have hopping. Each partitioned area can also have a mixed size RU and/or an MRU. Each partitioned area can also have a reserved or punctured area.

In some embodiments, to facilitate a rotating RU, dedicated signaling may be needed in the SIG fields for a receiver to properly interpret this new feature and parse relevant parameters for PPDU reception. That is, dedicated signal may be needed to provide information for reception of the PPDU with the rotating RU. The general design principle is to use less bits to signal and use implicit rules for rotating and hopping. There are two options. The first option involves signaling through unoccupied bits of Universal Signal (USIG) and unoccupied bits of Extremely High Throughput Signal (EHTSIG) (or its equivalent in UHR). These bits can be B20-B24 of a Universal Signal 1 (U-SIG1), B2 and B8 of Universal Signal 2 (U-SIG2), B13-B16 of common field of EHTSIG (or its equivalent in UHR). These bits can also be included in the RU Allocation subfield of EHTSIG (or its equivalent in UHR), which is in nine (9) bits with values 56-63 and 304-511 left for use. The second option involves signaling through extra symbols. These symbols can be dedicated new Signal (SIG) symbols. These symbols can also be the extension of user field of EHTSIG (or its equivalent in UHR). As a result of the extension, the total number of EHTSIG symbols (or its equivalent in UHR) would be greater.

In some embodiments, to facilitate the rotating RU, the designs of UHRSTF spatial mapping can be categorized into two cases. In the first case, where there is no transmit beamforming (TxBF), no special designs of UHRSTF spatial mapping are needed. For example, the existing EHTSTF spatial mapping matrix Q can be reused. In the second case, where there is TxBF, the UHRSTF spatial mapping matrix Q needs to be averaged across users. For example, for DL OFDMA to four (4) users, each user is assigned with RU52 rotating in full span of a 20 MHz PPDU, see FIG. 3. In this example, RU52[1] is visited by the four (4) users, where each user has its own spatial mapping matrix, i.e., Q(U1,RU52[1]), Q(U2,RU52[1]), Q(U3,RU52[1]), Q(U4,RU52[1]). Then UHRSTF may install the averaged spatial mapping matrix Q_ave(RU52[1])=ave(Q(U1,RU52[1]), Q(U2,RU52[1]), Q(U3,RU52[1]), Q(U4,RU52[1])).

The designs in both cases are applicable in full, partial and mixed spans. The designs in both cases can have hopping. The designs in both cases can have a mixed size RU and/or an MRU. The frequency resolution that needs averaged spatial mapping matrix is the smallest RU. The designs in both cases can have a reserved area, a punctured area or a partitioned area. For a reserved area, no averaged spatial mapping is needed. For a punctured area, the corresponding UHRSTF sequence is zeroed.

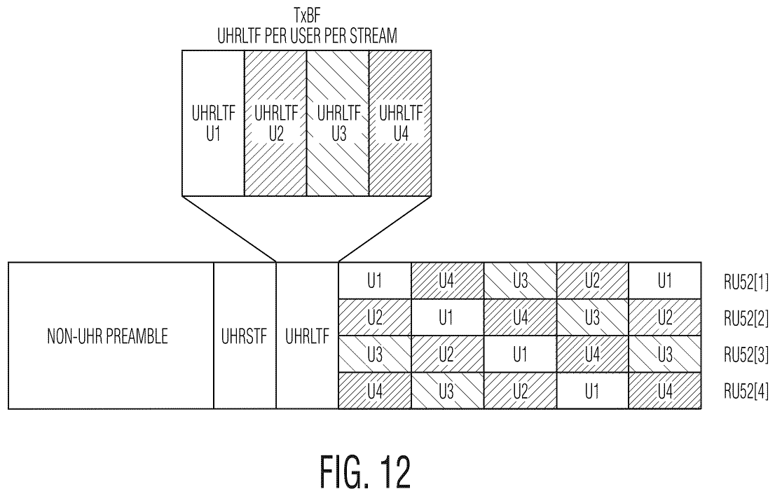

In some embodiments, to facilitate the rotating RU, the required number of UHRLTF symbols can be categorized into two cases. In the first case, where there is no TxBF, one UHRLTF symbol is sufficient, which is the same as in 802.11ax and 802.11be. In the second case, where there is TxBF, UHRLTF needs to be per user and per stream. For example, for DL OFDMA to four (4) users, each user is assigned with RU52 rotating in full span of a 20 MHz PPDU. In this example, each user can visit all available RUs, so its spatial mapping matrix has a full span. This requires UHRLTF to be per user and per stream, as shown in FIG. 12.

The designs in both cases are applicable in full, partial and mixed spans. For a partial span, each user has its unvisited RUs, see FIG. 4A, the corresponding UHRLTF sequence is zeroed in case 2 with TxBF. The designs in both cases can have hopping. The designs in both cases can have a mixed RU and an MRU. There are users with unvisited RUs, see FIG. 6 and FIG. 8, so their corresponding UHRLTF sequence are zeroed in the second case with TxBF. The designs in both cases can have a reserved area, a punctured area or a partitioned area. For a reserved area, see FIG. 9, the spatial mapping matrices of those users can be multiplexed in frequency with the spatial mapping matrices of those users in unreserved area in the second case with TxBF. This means no separate UHRLTF symbol is needed for those users in the reserved area. For a punctured area, see FIG. 10, the corresponding UHRLTF sequence is zeroed in both the first and second cases. For a partitioned area, the required number of UHRLTF symbols is the greatest across all partitioned areas. For example, see FIG. 11, the primary 20 MHz area needs four (4) UHRLTF symbols, the secondary 20 MHz area needs two (2) UHRLTF symbols, then four (4) UHRLTF symbols is needed in total and the secondary 20 MHz area can fill two (2) more UHRLTF symbols by repetition.

With growing number of Internet of things (IoT) devices, the provisioning of WiFi services faces new opportunities owing to the diverse end market needs. Amongst all, longer reach will be an essential Key Performance Indicator (KPI) for next-gen WiFi to extend its market share and create advantages over other technologies. Extended range (ER) PPDU format is already defined in both 802.11ax and 802.11be, but gaining only up to three (3) decibel (dB) range extension, which is insufficient for future usage. On the other hand, an ER solution based on orthogonal frequency-division multiplexing (OFDM) waveform is more future proof, and thus, preferable than relying on low-rate 802.11b for long range applications.

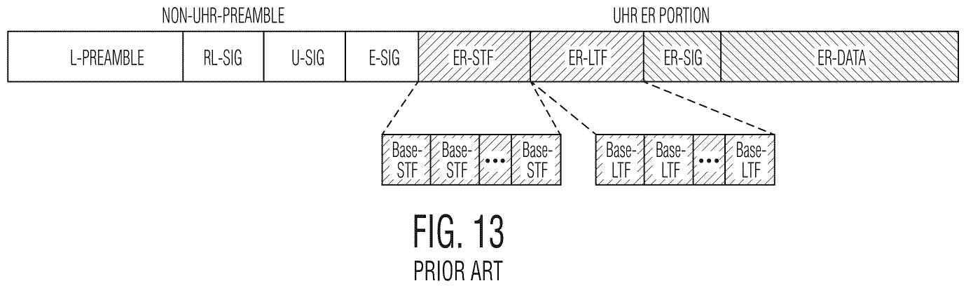

In 802.11b, singe-carrier waveform with direct sequence spread spectrum (DSSS) is used in 2.4 GHz, which has range extension benefits over OFDM. Existing methods in HE ER PPDU to achieve range extension are (1) legacy short training field (L-STF), legacy long training field (L-LTF), HE-STF and HE-LTF are boosted by three (3) dB, (2) legacy signal (L-SIG) and high efficiency signal A (HE-SIG-A) are repeated two times (2×) for better reception, and (3) HE-Data defines lower rate modulation, e.g. dual carrier modulation (DCM) and 106-tone DCM. To achieve further range extension under all bands (2.4/5/6 GHZ), one known approach designed an ER PPDU with (1) time domain (TD) repetition of extended range Short Training Field (ER-STF) and extended range Long Training Field (ER-LTF), potentially with power boost of three (3) dB, as illustrated in FIG. 13, (2) Hybrid TD repetition and frequency domain (FD) repetition of ER-SIG and ER-DATA (3) Several variants of TD repetition methods are defined, (4) One way of FD repetition is achieved through Duplicated DCM of 106-tone, 52-tone and 26-tone RU, and (5) Another way of FD repetition is achieved through direct RU repetition.

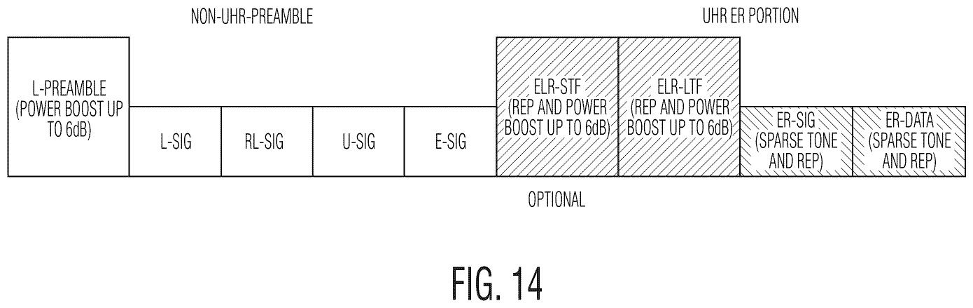

In accordance with embodiments of the invention, a new UHR ER PPDU with sparse tone plan is proposed, which is illustrated in FIG. 14, that is used to achieve range extension, support flexible rate and maintain clear channel assessment (CCA) compliance, where on the high level provides (a) L-Preamble with power boost, (b) ER-STF with power boost and TD repetitions, (c) ER-LTF with power boost and TD repetitions, and (d) ER-SIG and ER-DATA with sparse tone plan and TD repetitions. Sparse tone plan can be defined as a tone plan where less than half of the tones are used. In existing standards, one time (1×), two times (2×) and four times (4×) tone plans are defined for HE-LTF/EHT-LTF, but only 4× is used for DATA. The 4× tone plan is not a sparse tone plan. For example, two hundred and forty-two (242) tones are used out of two hundred fifty-six (256) tones for a 20 MHz PPDU. The 1× and 2× tone plans are basically four (4) times and two (2) times decimated from the 4× tone plan.

In some embodiments, to respond to CCA in two slots, power boost is needed on L-Preamble. Power boost options include (1) define power boost up to six (6) dB and (2) define power boost of three (3) dB and six (6) dB. Power boost may be provided on both L-STF and L-LTF.

In some embodiments, ER-STF can be used for timing refinement, gain adjustment, early ER PPDU detection, etc. ER-STF sequence options includes (1) the ER-STF sequence can be 8 microsecond (μs) per symbol, which is constructed from five (5) copies of trigger-based (TB) EHT-STF sequence with 1.6 μs period, (2) the ER-STF sequence can be 4 μs per symbol, which is constructed from five (5) copies of EHT-STF sequence with 0.8 μs period, (3) the ER-STF sequence can be 4 μs per symbol, which is constructed from five (5) copies of VHT-STF sequence with 0.8 μs period, and (4) the ER-STF sequence can be 4 μs per symbol, which is constructed from five (5) copies of L-STF sequence with 0.8 μs period. Power boost options include (1) define power boost up to six (6) dB and (2) define power boost of three (3) dB and six (6) dB. TD repetition can be 2×, 4×, 8× and 16×. Any combinations of power boost and TD repetitions are possible.

In some embodiments, ER-LTF can be used to refine carrier frequency offset (CFO), carry out channel estimation, etc. The ER-LTF sequence options include (1) 4×EHT-LTF with 0.8 μs, 1.6 μs and 3.2 μs cyclic prefix (CP) (note that 4×EHT-LTF with 1.6 μs is new), (2) 2×EHT-LTF with 0.8 μs, 1.6 μs and 3.2 μs CP (note that 2×EHT-LTF with 3.2 μs is new), (3) VHT-LTF with 0.8 μs, 1.6 μs and 3.2 μs CP (note that VHT-LTF with 1.6 μs and 3.2 μs is new), and (4) L-LTF with 0.8 μs, 1.6 μs and 3.2 μs CP (note that L-LTF with 1.6 μs and 3.2 μs is new). Power boost options include (1) define power boost up to six (6) dB and (2) define power boost of three (3) dB and six (6) dB. TD repetition can be 2×, 4×, 8×, 16× and 32×. Any combinations of power boost and TD repetitions are possible.

In some embodiments, the sparse tone plan may support one (1) megabits per second (Mbps) with twenty-eight (28) data tones. There are three options for these embodiments. In the first option, with two (2) pilot tones, 0.5× tone plan for ER-SIG and ER-DATA is introduced, which is constructed from 2× decimation of the existing 1× tone plan for a 20 MHz PPDU. The results are thirty (30) tones in total [−120:8:−8, 8:8:120], including twenty-eight (28) data tones plus two (2) pilot tones [−48, 48]. In the second option, with four (4) pilot tones, the existing 1× tone plan is modified to get twenty-eight (28) data tones (same as the first option) plus four (4) pilot tones [−116,−48, 48, 116]. Alternatively, the existing 1× tone plan is modified by choosing thirty-two (32) tones in total and then assigning twenty-eight (28) data tones plus four (4) pilot tones. As an example, for uniform loading, there are thirty-two (32) tones in total [−92:4:−32,32:4:92], including twenty-eight (28) data tones plus four (4) pilot tones [−76,−48, 48, 76]. In this case, ER-LTF may need to have a matching tone plan. In the third option, with eight (8) pilot tones, the existing 2× tone plan is modified to get twenty-eight (28) data tones (same as the first option) plus eight (8) pilot tones [−116,−90,−48,−22, 22, 48, 90, 116]. Alternatively, the existing 1× tone plan is modified by choosing thirty-six (36) tones in total and then assigning twenty-eight (28) data tones plus eight (8) pilot tones. As an example, for uniform loading, there are thirty-six (36) tones in total [−96:4:−28, 28:4:96], including twenty-eight (28) data tones plus eight (8) pilot tones [−88,−76,−48,−36, 36, 48, 76, 88]. In this case, ER-LTF may need to have a matching tone plan. With CP of 1.6 μs (0.8 μs and 3.2 μs), the data rate is 0.9722 Mbps (1.0294 and 0.8750 Mbps).

In some embodiments, the sparse tone plan may support one (1) Mbps with twenty-four (24) data tones. There are three options for these embodiments. In the first option, with two (2) pilot tones, the newly introduced 0.5× tone plan is modified to get twenty-four (24) data tones plus two (2) pilot tones. As an example, there are twenty-six (26) tones in total [−112:8:−16, 16:8:112], including twenty-four (24) data tones plus two (2) pilot tones [−48, 48]. In the second option, with four (4) pilot tones, the existing 1× tone plan is modified to get twenty-four (24) data tones (same as the first option) plus four (4) pilot tones [−116,−48, 48, 116]. The twenty-four (24) data tones in the first option should not contain the four (4) pilot tones. Alternatively, the newly introduced 0.5× tone plan is modified by choosing twenty-eight (28) tones in total and then assigning twenty-four (24) data tones plus four (4) pilot tones. As an example, for uniform loading, there are twenty-eight (28) tones in total [−120:8:−16, 16:8:120], including twenty-four (24) data tones plus four (4) pilot tones [−88,−48, 48, 88]. In this case, ER-LTF needs to have a matching tone plan. In the third option, with eight (8) pilot tones, the existing 2× tone plan is modified to get twenty-four (24) data tones (same as the first option) plus eight (8) pilot tones [−116,−90,−48,−22, 22, 48, 90, 116]. In this case, the twenty-four (24) data tones in the first option should not contain the eight (8) pilot tones. Alternatively, the existing 1× tone plan is modified by choosing thirty-two (32) tones in total and then assigning twenty-four (24) data tones plus eight (8) pilot tones. As an example, for uniform loading, there are thirty-two (32) tones in total [−92:4:−32, 32:4:92], including twenty-four (24) data tones plus eight (8) pilot tones. In this case, ER-LTF may need to have a matching tone plan. In these embodiments, a new Modulation Coding Scheme (MCS): Binary Phase Shift Keying (BPSK)+2/3 coding rate may need to be defined. With CP of 3.2 μs (0.8 μs and 1.6 μs), the data rate is one (1) Mbps (1.1765 and 1.1111 Mbps).

In some embodiments, the sparse tone plan may support two (2) Mbps with fifty-six (56) data tones. There are two options for these embodiments. In the first option, with four (4) pilot tones, 1× tone plan for ER-SIG and ER-DATA, inherited from the existing 1× tone plan for a 20 MHz PPDU, is allowed. In this option, there are sixty (60) tones in total [−120:4:−4, 4:4:120], including fifty-six (56) data tones plus four (4) pilot tones [−116,−48, 48, 116]. In the second option, with eight (8) pilot tones, the existing 2× tone plan is modified to get fifty-six (56) data tones plus four (4) pilot tones [−116,−48, 48, 116]. Alternatively, the existing 2× tone plan is modified by choosing sixty-four (64) tones in total and then assigning fifty-six (56) data tones plus eight (8) pilot tones. As an example, for uniform loading, there are sixty-four (64) tones in total [−94:2:−32, 32:2:94], including fifty-six (56) data tones plus eight (8) pilot tones [−88,−76,−48,−36, 36, 48, 76, 88]. With CP of 1.6 μs (0.8 μs and 3.2 μs), the data rate is 1.9444 Mbps (2.0588 and 1.7500 Mbps). With 2× TD repetition, these tone plans can also be used to support one (1) Mbps. CP in between repetitions can be removed.

In some embodiments, the sparse tone plan may support two (2) Mbps with forty-eight (48) data tones. There are two options for these embodiments. In the first option, with four (4) pilot tones, the existing 1× tone plan is modified to get forty-eight (48) data tones plus four (4) pilot tones. As an example, there are fifty-two (52) tones in total [−120:4:−20, 20:4:120], including forty-eight (48) data tones plus four (4) pilot tones [−116,−48, 48, 116]. In the second option, with eight (8) pilot tones, the existing 2× tone plan is modified to get forty-eight (48) data tones (same as the first option) plus eight (8) pilot tones [−116,−90,−48,−22, 22, 48, 90, 116]. The forty-eight (48) data tones in the first option should not contain eight (8) pilot tones. Alternatively, the existing 1× tone plan is modified by choosing fifty-six (56) tones in total and then assigning forty-eight (48) data tones plus eight (8) pilot tones. As an example, for uniform loading, there are fifty-six (56) tones in total [−120:4:−12, 12:4:120], including forty-eight (48) data tones plus eight (8) pilot tones [−116,−88,−48,−20, 20, 48, 88, 116]. In this case, ER-LTF may need to have a matching tone plan. In these embodiments, a new MCS: BPSK+2/3 coding rate may be needed. With CP of 3.2 μs (0.8 μs and 1.6 μs), the data rate is two (2) Mbps (2.3529 and 2.2222 Mbps). With 2× TD repetition, these tone plans can also be used to support 1 Mbps.

In some embodiments, the sparse tone plan may support four (4) Mbps. There are two options for these embodiments. In the first option, with eight (8) pilot tones, 2× tone plan for ER-SIG and ER-DATA, inherited from the existing 2× tone plan for a 20 MHz PPDU, is allowed. In this option, there are one hundred twenty-two (122) tones in total [−122:2:−2, 2:2:122], including one hundred fourteen (114) data tones plus eight (8) pilot tones [−116,−90,−48,−22, 22, 48, 90, 116]. With CP of 1.6 μs (0.8 μs and 3.2 μs), the data rate is 3.9583 Mbps (4.1912 and 3.5625 Mbps). In the second option, with eight (8) pilot tones, the existing 2× tone plan is modified to get ninety-six (96) data tones plus eight (8) pilot tones [−116,−90,−48,−22, 22, 48, 90, 116]. In this option, a new MCS: BPSK+2/3 coding rate may be needed. With CP of 3.2 μs (0.8 μs and 1.6 μs), the data rates are four (4) Mbps (4.7059 and 4.4444 Mbps). With 2× TD repetition, these tone plans can also be used to support two (2) Mbps. With 4× TD repetition, these tone plans can also be used to support one (1) Mbps.

In some embodiments, the sparse tone plan may support 1.5 Mbps with forty-eight (48) data tones. There are three options for these embodiments. In the first option, with four (4) pilot tones, the existing 1× tone plan is modified to get forty-eight (48) data tones plus four (4) pilot tones. As an example, there are fifty-two (52) tones in total [−120:4:−20, 20:4:120], including forty-eight (48) data tones plus four (4) pilot tones [−116,−48, 48, 116]. In the second option, with eight (8) pilot tones, the existing 2× tone plan is modified to get forty-eight (48) data tones (same as the first option) plus eight (8) pilot tones [−116,−90,−48,−22, 22, 48, 90, 116]. The forty-eight (48) data tones in the first option should not contain the eight (8) pilot tones. Alternatively, the existing 1× tone plan is modified by choosing fifty-six (56) tones in total and then assigning forty-eight (48) data tones plus eight (8) pilot tones. As an example, for uniform loading, there are fifty-six (56) tones in total [−120:4:−12, 12:4:120], including forty-eight (48) data tones plus eight (8) pilot tones [−116,−88,−48,−20, 20, 48, 88, 116]. In this case, ER-LTF may need to have a matching tone plan. In the third option, 802.11a tone plan is mapped to 1× tone plan. In this option, there are fifty-two (52) tones in total [−104:4:−4, 4:4:104], including forty-eight (48) data tones plus four (4) pilot tones [−84,−28, 28, 84]. In this case, ER-LTF may need to have a matching tone plan. With CP of 3.2 μs (0.8 μs and 1.6 μs), the data rate is 1.5 Mbps (1.7647 and 1.6667 Mbps).

In some embodiments, the sparse tone plan may support 1.5 Mbps with fifty-two (52) data tones. There are three options for these embodiments. In the first option, with four (4) pilot tones, the existing 1× tone plan is modified to get fifty-two (52) data tones plus four (4) pilot tones. As an example, there are fifty-six (56) tones in total [−120:4:−12, 12:4:120], including fifty-two (52) data tones plus four (4) pilot tones [−116,−48, 48, 116]. In the second option, with eight (8) pilot tones, the existing 2× tone plan is modified to get fifty-two (52) data tones (same as the first option) plus eight (8) pilot tones [−116,−90,−48,−22, 22, 48, 90, 116]. The fifty-two (52) data tones in the first option should not contain eight (8) pilot tones. Alternatively, the existing 1× tone plan is modified by choosing sixty (60) tones in total and then assigning fifty-two (52) data tones plus eight (8) pilot tones. As an example, for uniform loading, there are fifty-six (56) tones in total [−120:4:−4, 4:4:120], including fifty-two (52) data tones plus eight (8) pilot tones [−116,−88,−48,−20, 20, 48, 88, 116]. In this case, ER-LTF may need to have a matching tone plan. In the third option, 802.11ac tone plan is mapped to 1× tone plan. In this option, there are fifty-six (56) tones in total [−112:4:−4, 4:4:112], including fifty-two (52) data tones plus four (4) pilot tones [−84,−28, 28, 84]. In this case, ER-LTF may need to have a matching tone plan. With CP of 3.2 μs (0.8 μs and 1.6 μs), the data rate is 1.6250 Mbps (1.9118 and 1.8056 Mbps).

In some embodiments, the sparse tone plan may support three (3) Mbps with one hundred two (102) data tones. With eight (8) pilot tones, the existing 2× tone plan is modified to get one hundred two (102) data tones plus eight (8) pilot tones. As an example, there are one hundred ten (110) tones in total [−122:2:−14, 14:2:122], including one hundred two (102) data tones plus eight (8) pilot tones [−116,−90,−48,−22, 22, 48, 90, 116]. With CP of 3.2 μs (0.8 μs and 1.6 μs), the data rates are 3.1875 Mbps (3.7500 and 3.5417 Mbps). With 2× TD repetition, this tone plan can also be used to support 1.5 Mbps.

In the various tone plans, low density parity check (LDPC) Tone Mapper, Binary Convolutionally Encoded (BCC) Interleaver and N_SD_short parameters may need to be defined as follows. With twenty-eight (28) total tones, N_SD_short=6. With thirty (30) total tones, N_SD_short=7. With thirty-two (32) total tones, N_SD_short=7. With thirty-six (36) total tones, N_SD_short=8. With fifty-six (56) data tones, N_SD_short=13. With sixty (60) data tones, N_SD_short=14. With sixty-four (64) data tones, N_SD_short=15. With one hundred four (104) data tones, N_SD_short=24. With one hundred twenty-two (122) data tones, N_SD_short=28. With twenty-eight (28) data tones, D_TM=1 (can also be factors of 28), N_COL=7 (can also be factors of 28), and N_ROT needs to be redefined with an example being 4. With fifty-six (56) data tones, D_TM=4 (can also be factors of 56), N_COL=14 (can also be factors of 56), and N_ROT needs to be redefined with an example being 16. With ninety-six (96) data tones, D_TM=6 (can also be factors of 96), N_COL=16 (can also be factors of 96), and N_ROT needs to be redefined with an example being 24. With one hundred fourteen (114) data tones, D_TM=6 (can also be factors of 102), N_COL=19 (can also be factors of 114), and N_ROT needs to be redefined with an example being 30.

In some embodiments, methods are used to alleviate spectrum issue, i.e., spectrum regrowth, due to TD repetitions. There are three options to alleviate this spectrum issue. The first option involves offsetting spare tone plan. For example, for an original spare tone plan supporting one (1) Mbps with twenty-eight (28) data tones, where there are twenty-eight (28) data tones [−120:8:−56,−40:8:−8, 8:8:40, 56:8:120] plus eight (8) pilot tones [−116,−90,−48,−22, 22, 48, 90, 116], an offset spare tone plan supporting 1 Mbps with 28 data tones is used, where there are twenty-eight (28) data tones [−119:8:−55,−41:8:−9, 9:8:41, 55:8:119] plus eight (8) pilot tones [−116,−90,−48,−22, 22, 48, 90, 116]. The second option involves using a non-uniform sparse tone plan. For example, for an original spare tone plan supporting (1) Mbps with twenty-eight (28) data tones, where there are twenty-eight (28) data tones [−120:8:−56,−40:8:−8, 8:8:40, 56:8:120] plus eight (8) pilot tones [−116,−90,−48,−22, 22, 48, 90, 116], a non-uniform sparse tone plan supporting (1) Mbps with twenty-eight (28) data tones is used, where there are twenty-eight (28) data tones [−120:8:−56,−20:3:−8, 8:3:20, 56:8:120] plus eight (8) pilot tones [−116,−90,−48,−22, 22, 48, 90, 116]. The third option is using a combination of the first and second options.

In some embodiments, there are other methods to support one (1) Mbps, 1.5 Mbps, two (2) Mbps, three (3) Mbps and four (4) Mbps. For 802.11ac tone plan with TD repetitions, the following methods may be used (1) 1× TD repetitions with CP of 3.2 μs, where the data rate is 4.0625 Mbps, (2) 2× TD repetitions with CP of 3.2 μs, where the data rate is 2.0313 Mbps, (3) 4× TD repetitions with CP of 3.2 μs, where the data rate is 1.0156 Mbps, and (4) 8× TD repetitions and CP removed in between TD repetitions, with CP of 1.6 μs, where the data rate is 0.9559 Mbps. For 802.11a tone plan with TD repetitions, the following methods may be used (1) 2× TD repetitions with CP of 0.8 μs, where the data rate is 3 Mbps, (2) 4× TD repetitions with CP of 0.8 μs, where the data rate is 1.5 Mbps, (3) 2× TD repetitions and CP removed in between TD repetitions, with CP of 1.6 μs, where the data rate is 3 Mbps, and (4) 4× TD repetitions and CP removed in between TD repetitions, with CP of 3.2 μs, where the data rate is 1.5 Mbps.

In some embodiments, there may be sparse tone plan with fifty-two (52) data tones. There are three options for these embodiments. In the first option, with four (4) pilot tones, fifty-six (56) tones (fifty-two (52) data tones and 4 pilot tones) are assigned over the existing 4× tone plan. As an example, there are fifty-six (56) tones in total [−120:4:−12, 12:4:120], including fifty-two (52) data tones plus four (4) pilot tones [−116,−48, 48, 116]. In the second option, sixty (60) tones (fifty-two (52) data tones and eight (8) pilot tones) are assigned over the existing 4× tone plan. As an example, there are fifty-two (52) data tones (same as the first option) plus eight (8) pilot tones [−116,−90,−48,−22, 22, 48, 90, 116]. As another example, there are sixty (60) tones in total [−120:4:−4, 4:4:120], including fifty-two (52) data tones plus eight (8) pilot tones [−116,−88,−48,−20, 20, 48, 88, 116]. In this case, data tones and pilot tones of 4× tone plan are repurposed. In the third option, 802.11ac tone plan is mapped to 4× tone plan. In this option, there are fifty-six (56) tones in total [−112:4:−4, 4:4:112], including fifty-two (52) data tones plus four (4) pilot tones [−84,−28, 28, 84]. In this case, data tones and pilot tones of 4× tone plan are repurposed. This is identical to 4× TD repetition of 802.11ac tone plan with CP removed in between repetitions. In some embodiments, offset sparse tone plan may be used to alleviate TD repetition effects. Offset may be added in FD to the spare tone plans. In the example for the first option, the fifty-six (56) tones become fifty-two (52) data tones [−121:4:−21, 21:4:121] plus four (4) pilot tones [−116,−48, 48, 116] or [−90,−22, 22, 90].

In some embodiments, there may be sparse tone plan with forty-eight (48) data tones. There are three options for these embodiments. In the first option, with four (4) pilot tones, fifty-two (52) tones (forty-eight (48) data tones and 4 pilot tones) are assigned over the existing 4× tone plan. As an example, there are fifty-two (52) tones in total [−120:4:−20, 20:4:120], including forty-eight (48) data tones plus four (4) pilot tones [−116,−48, 48, 116]. In the second option, fifty-six (56) tones (forty-eight (48) data tones and eight (8) pilot tones) are assigned over the existing 4× tone plan. As an example, there are forty-eight (48) data tones (same as the first option) plus 8 pilot tones [−116,−90,−48,−22, 22, 48, 90, 116]. As another example, there are fifty-six (56) tones in total [−120:4:−12, 12:4:120], including forty-eight (48) data tones plus eight (8) pilot tones [−116,−88,−48,−20, 20, 48, 88, 116]. In this case, data tones and pilot tones of 4× tone plan are repurposed. In the third option, 802.11a tone plan is mapped to 4× tone plan. In this option, there are fifty-two (52) tones in total [−104:4:−4, 4:4:104], including forty-eight (48) data tones plus four (4) pilot tones [−84,−28, 28, 84]. In this case, data tones and pilot tones of 4× tone plan are repurposed. This is identical to 4× TD repetition of 802.11a tone plan with CP removed in between repetitions. In some embodiments, offset sparse tone plan may be used to alleviate TD repetition effects. Offset may be added in FD to the spare tone plans. In the example for the first option, the fifty-two (52) tones become forty-eight (48) data tones [−121:4:−29, 29:4:121] plus four (4) pilot tones [−116,−48, 48, 116] or [−90,−22, 22, 90].

In some embodiments, the sparse tone plans with forty-eight (48) and fifty-two (52) data tones may support 1.5 Mbps minimum rate. Sparse tone plan with fifty-two (52) data tones can be used to support 1.5 Mbps minimum rate. With CP of 3.2 μs, the data rates are 1.6250 Mbps. Sparse tone plan with forty-eight (48) data tones can be used to support 1.5 Mbps minimum rate. With CP of 3.2 μs, the data rates are 1.5 Mbps.

In some embodiments, the sparse tone plan with fifty-two (52) data tones can be used to support one (1) Mbps minimum rate. In this sparse tone plan, 2× TD repetition with no CP in between repetitions is used. With CP of 1.6 μs, the data rate is 0.956 Mbps. There are four options for TD repetitions. In the first option, TD repetitions can be direct repetitions. In the second option, TD repetitions can apply phase rotation on the data for the second copy. In the third option, TD repetitions can use different sparse tone plan for two copies. As an example, with four (4) pilots, the first repetition can have fifty-six (56) tones in total [−120:4:−12, 12:4:120], including fifty-two (52) data tones plus four (4) pilot tones [−116, −48, 48, 116], and the second repetition can have fifty-six (56) tones in total [−122:4:−14, 14:4:122], including fifty-two (52) data tones plus four (4) pilot tones [−90,−22, 22, 90]. As another example, with eight (8) pilots, the first repetition can have sixty (60) tones in total [−120:4:−12, 12:4:120], including fifty-two (52) data tones plus eight (8) pilot tones [−116,−90, −48,−22, 22, 48, 90, 116], and the second repetition can have sixty (60) tones in total [−122:4:−14, 14:4:122], including fifty-two (52) data tones plus eight (8) pilot tones [−116,−90, −48,−22, 22, 48, 90, 116]. In the fourth option, there can be a combination of the second option and the third option.

In some embodiments, UHR ER device has to indicate its capability during initial setup and association. This information can be included in a management frame. This can be indicated in UHR PHY Capabilities Information field of UHR Capabilities element. This can also be indicated in Supported UHR-MCS and NSS Set field of UHR Capabilities element.

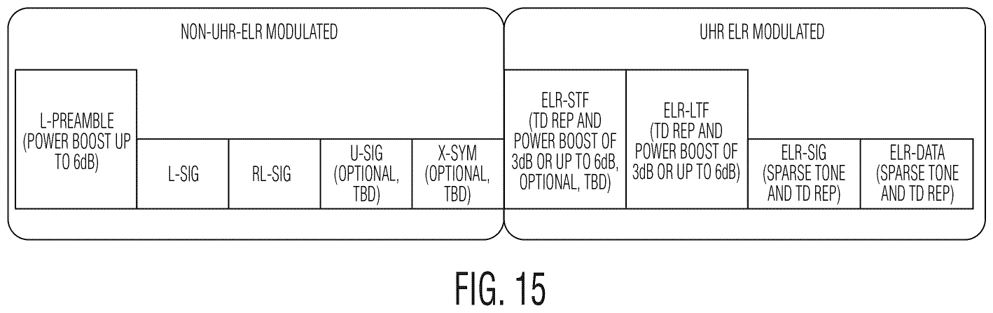

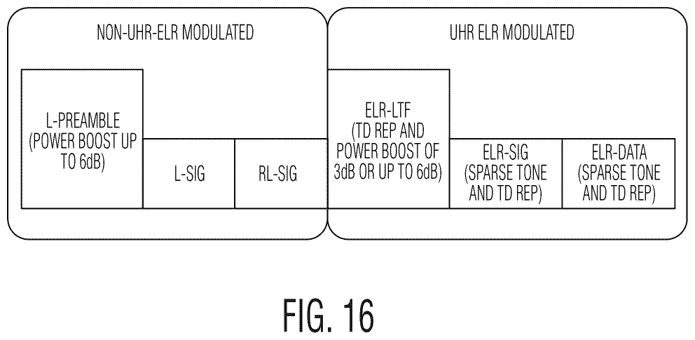

In some embodiments, as illustrated in FIG. 15, L-SIG and repeated legacy signal (RL-SIG) may use 802.11ax format (L-LENGTH % 3!=0), so both 802.11ax and 802.11be 3^{rd} party STAs in the field would have less chance hitting the false L-SIG parity check. Either (L-LENGTH % 3==1) or (L-LENGTH % 3==2) may be chosen for the design. Furthermore, Universal Signal (U-SIG) is optional. If U-SIG is removed, as illustrated in FIG. 16, then BSS color, Transmit opportunity (TXOP), PHY Version Identifier can be included in enhanced long range signal (ELR-SIG) (in this case, ELR-SIG is future proof and universal). In some embodiments, enhanced long range long training field (ELR-LTF) can serve as the signature symbol for format detection. There are four options. In the first option, ELR-LTF itself is a known repeated sequence, which allows correlation and repetition check. In the second option, in FD, different phases (common phase rotation) are applied on different copies of ELR-LTFs, which allows polarity check. In the third option, in FD, different phase rotated sequences (per-tone phase rotation) are applied on different copies of ELR-LTFs, which allows sequence (differential) detection. In the fourth option, in TD, masking sequences (or differential encoding) are applied on different copies of ELR-LTFs, which allows sequence (differential) detection.

FIG. 11 depicts a wireless device 1700 in accordance with an embodiment of the invention. The wireless device 1700 can be used in the multi-link communications system 100 depicted in FIG. 1. For example, the wireless device 1700 may be an embodiment of the AP MLD 102 or the non-AP STA MLD 104 depicted in FIG. 1.

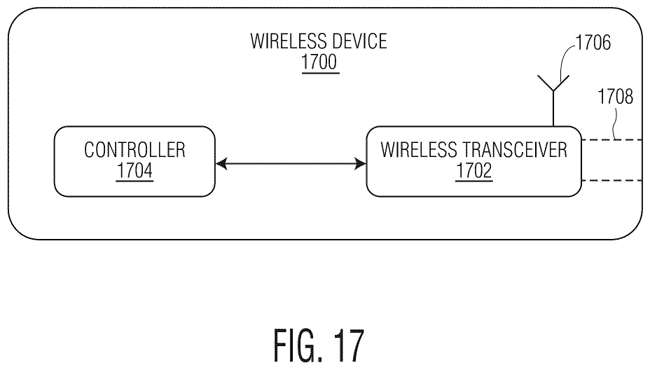

In the embodiment depicted in FIG. 17, the wireless device 1700 includes a wireless transceiver 1702, a controller 1704 operably connected to the wireless transceiver, and at least one antenna 1706 operably connected to the wireless transceiver. In some embodiments, the wireless device 1700 may include at least one optional network port 1708 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 1100 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port.

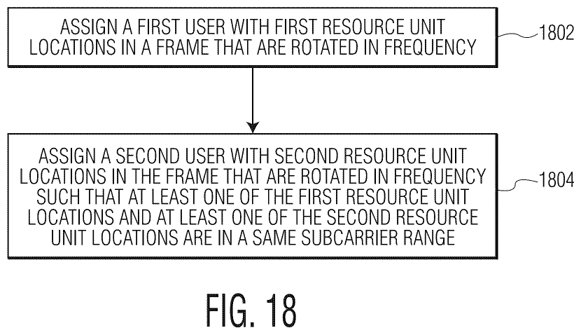

A method of transmitting a frame in a communications system in accordance with an embodiment of the invention is described with reference to a flow diagram of FIG. 18. At block 1802, a first user is assigned with first resource unit locations in the frame that are rotated in frequency. At block 1804, a second user is assigned with second resource unit locations in the frame that are rotated in frequency such that at least one of the first resource unit locations and at least one of the second resource unit locations are in a same subcarrier range.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A wireless device comprising:
a wireless transceiver to receive and transmit frames; and
a controller operably coupled to the wireless transceiver to process the frames, wherein the controller is configured to generate at least one frame that includes a resource unit for a first user that is rotated in frequency such that a first frequency location of the resource unit for a first time period is different than a second frequency location of the resource unit for a second time period.

2. The wireless device of claim 1, wherein the controller is configured to assign frequency locations of the resource unit in one of a full span, a partial span and a mixed span, wherein the full span is a span where a total available bandwidth is visited by the resource unit, wherein the partial span is a span where less than the total available bandwidth is visited by the resource unit, and the mixed span is a span that includes at least one full span and at least one partial span.

3. The wireless device of claim 1, wherein the controller is configured to assign frequency locations of the resource unit such that at least one frequency range is hopped by the frequency locations of the resource unit.

4. The wireless device of claim 1, wherein the controller is configured to assign frequency locations of the resource unit such that the frequency locations have mixed sizes.

5. The wireless device of claim 1, wherein the resource unit includes a multiple resource unit.

6. The wireless device of claim 1, wherein the controller is configured to assign frequency locations of the resource unit such that one of a punctured area, a reserved area and a partitioned area of a total available bandwidth is not visited by the resource unit.

7. The wireless device of claim 1, wherein the controller is configured to use unoccupied bits of a signal element of the frame or symbols in the frame to provide information for reception of the frame with the resource unit.

8. The wireless device of claim 1, wherein the controller is configured to use an existing spatial mapping matrix when there is no transmit beamforming, and use an averaged spatial mapping matrix when there is transmit beamforming.

9. The wireless device of claim 1, wherein the controller is configured to use one long training field when there is no transmit beamforming, and use a long training field per user when there is no transmit beamforming.

10. The wireless device of claim 1, wherein the controller is configured to generate a long training field in the frame with a sparse tone plan, wherein the sparse tone plan uses less than half of available tones.

11. The wireless device of claim 10, wherein the controller is configured to generate a preamble in the frame that is power boosted by up to one of six (6) decibels or power boosted to three (3) decibels and six (6) decibels.

12. The wireless device of claim 10, wherein the controller is configured to generate a short or long training field in the frame that is power boosted, wherein a time domain repetition is applied to the short or long training field.

13. The wireless device of claim 10, wherein the sparse tone plan includes at least one of twenty-four (24) data tones, twenty-eight (28) data tones, forty-eight (48) data tones, fifty-two (52), data tones fifty-six (56) data tones, ninety-six (96) data tones, one hundred two (102) data tones, and one hundred fourteen (114) data tones.

14. The wireless device of claim 10, wherein the sparse tone plan includes a particular number of data tones to support at least one of one (1) megabits per second, 1.5 megabits per second, two (2) megabits per second, three (3) megabits per second, and four (4) megabits per second.

15. The wireless device of claim 10, wherein the sparse tone plan is one of an offset sparse tone plan and a non-uniform sparse tone plan.

16. A method of transmitting a frame in a communications system, the method comprising:
assigning a first user with first resource unit locations in the frame that are rotated in frequency; and
assigning a second user with second resource unit locations in the frame that are rotated in frequency such that at least one of the first resource unit locations and at least one of the second resource unit locations are in a same subcarrier range.

17. The method of claim 16, wherein assigning the first user with the first resource unit locations in the frame includes assigning the first resource unit locations in one of a full span, a partial span and a mixed span, wherein the full span is a span where a total available bandwidth is visited by a resource unit associated with the first resource unit locations, wherein the partial span is a span where less than the total available bandwidth is visited by the resource unit, and the mixed span is a span that includes at least one full span and at least one partial span.

18. A wireless device comprising:
a wireless transceiver to receive and transmit frames; and
a controller operably coupled to the wireless transceiver to process the frames, wherein the controller is configured to generate at one frame that includes first resource unit locations in the frame for a first user that are rotated in frequency and second resource unit locations in the frame for a second user that are rotated in frequency such that at least one of the first resource unit locations and at least one of the second resource unit locations are in a same subcarrier range.

19. The wireless device of claim 18, wherein the controller is configured to assign the first resource unit locations in one of a full span, a partial span and a mixed span, wherein the full span is a span where a total available bandwidth is visited by a resource unit associated with the first resource unit locations, wherein the partial span is a span where less than the total available bandwidth is visited by the resource unit, and the mixed span is a span that includes at least one full span and at least one partial span.

20. The wireless device of claim 1, wherein the controller is configured to assign the first resource unit locations such that at least one frequency range is hopped by the first resource unit locations.
